(19) United States
(12) Patent Application Publication
(10) Pub. No.: US 2025/0148736 A1
(43) Pub. Date: May 8, 2025

(54) PHOTOREALISTIC SYNTHESIS OF AGENTS IN TRAFFIC SCENES

(71) Applicant: NEC Laboratories America, Inc., Princeton, NJ (US)

(72) Inventors: Bingbing Zhuang, Santa Clara, CA (US); Ziyu Jiang, Sunnyvale, CA (US); Manmohan Chandraker, Santa Clara, CA (US); Shanlin Sun, Irvine, CA (US)

(21) Appl. No.: 18/924,258

(22) Filed: Oct. 23, 2024

Related U.S. Application Data
(60) Provisional application No. 63/596,727, filed on Nov. 7, 2023.

(51) Int. Cl. G06T 19/20; G06T 1/20; G06T 7/246; G06T 7/90; G06T 15/00; G06T 15/06; G06T 15/20; G06T 15/50

(52) U.S. Cl. CPC G06T 19/20; G06T 1/20; G06T 7/246; G06T 7/90; G06T 15/005; G06T 15/06; G06T 15/205; G06T 15/506; G06T 2207/10016; G06T 2207/20084; G06T 2207/30236; G06T 2207/30241; G06T 2219/2008

(57) ABSTRACT

A computer-implemented method for synthesizing an image includes extracting agent neural radiance fields (NeRFs) from driving video logs and storing agent NeRFs in a database. For a driving video log to be edited, a scene NeRF and agent NeRFs are extracted from the driving video log to be edited. One or more agent NeRFs are selected from the database to insert into or replace existing agents in a traffic scene of the driving video log based on photorealism criteria. The traffic scene is edited by inserting a selected agent NeRF into the traffic scene, replacing existing agents in the traffic scene with the selected agent NeRF, or removing one or more existing agents from the traffic scene. An image of the edited traffic scene is synthesized by composing edited agent NeRFs with the scene NeRF and performing volume rendering.

### RELATED APPLICATION INFORMATION

This application claims priority to U.S. Provisional Patent Application No. 63/596,727 filed on Nov. 7, 2023, incorporated herein by reference in its entirety.

### BACKGROUND

### Technical Field

The present invention relates to artificial intelligence (AI) systems, and more particularly, to synthesizing traffic scenes by including or substituting traffic agents in a scene from a repository.

### Description of the Related Art

Robust simulation systems are an important tool in self-driving and advanced driving assistance systems (ADAS), as they offer a cost-effective and scalable way for training and verification of autonomy, especially in safety-critical scenarios. Traditional methods typically approach this problem by manual three-dimensional (3D) asset creation followed by procedural computer graphic rendering pipelines. These pipelines require large amounts of human effort, and the results are not scalable or cost-effective.

### SUMMARY

According to an aspect of the present invention, a computer-implemented method for synthesizing an image includes extracting agent neural radiance fields (NeRFs) from driving video logs and storing agent NeRFs in a database. For a driving video log to be edited, a scene NeRF and an agent NeRF are extracted from the driving video log to be edited. One or more agent NeRFs are selected from the database to insert into or replace existing agents in a traffic scene of the driving video log based on photorealism criteria. The traffic scene is edited by inserting the selected agent NeRFs into the traffic scene, replacing existing agents in the traffic scene with the selected agent NeRFs, or removing one or more existing agents from the traffic scene. An image of the edited traffic scene is synthesized by composing the edited agent NeRFs with the scene NeRF and performing volume rendering.

According to another aspect of the present invention, a system for synthesizing an image includes a hardware processor and a memory storing a computer program which, when executed by the hardware processor, causes the hardware processor to extract agent neural radiance fields (NeRFs) from driving video logs and store agent NeRFs in a database. For a driving video log to be edited, a scene NeRF and an agent NeRF are extracted from the driving video log to be edited. One or more agent NeRFs are selected from the database to insert into or replace existing agents in a traffic scene of the driving video log based on photorealism criteria. The traffic scene is edited by at least one of inserting the selected agent NeRFs into the traffic scene, replacing existing agents in the traffic scene with the selected agent NeRFs, or removing one or more existing agents from the traffic scene. An image is synthesized of the edited traffic scene by composing the edited agent NeRFs with the scene NeRF and performing volume rendering.

According to another aspect of the present invention, a non-transitory computer-readable storage medium storing instructions that, when executed by a processor, cause the processor to perform a method for synthesizing an image, the method comprising: extracting agent neural radiance fields (NeRFs) from driving video logs; store agent NeRFs in a database; for a driving video log to be edited, extracting a scene NeRF and an agent NeRF from the driving video log to be edited; selecting one or more agent NeRFs from the database to insert into or replace existing agents in a traffic scene of the driving video log based on photorealism criteria; editing the traffic scene by at least one of inserting the selected agent NeRFs into the traffic scene, replacing existing agents in the traffic scene with the selected agent NeRFs, or removing one or more existing agents from the traffic scene; and synthesize an image of the edited traffic scene by composing the edited agent NeRFs with the scene NeRF and performing volume rendering.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a system/method for synthesizing images by inserting, replacing or removing agents, in accordance with an embodiment of the present invention;.

FIG. 2 is a block/flow diagram illustrating a scene to be edited and a synthesized scene generated therefrom, in accordance with an embodiment of the present invention;.

FIG. 3 is a block/flow diagram illustrating a system/method for synthesizing images, in accordance with an embodiment of the present invention;.

FIG. 4 is a flow diagram illustrating methods for synthesizing images using photorealism criteria, in accordance with an embodiment of the present invention; and

FIG. 5 is a schematic diagram showing an autonomous vehicle system which employs self-training using synthesized images, in accordance with embodiments of the present invention.

### DETAILED DESCRIPTION OF PREFERRED EMBODIMENTS

In accordance with embodiments of the present invention, systems and methods are described that provide camera and image simulation with high resolution and rich semantics to employ neural radiance field (NeRF) to develop a fully automatic pipeline for image simulation. The present systems take as input real driving logs, build a 3D digital twin (e.g., 3D reconstruction with NeRF) for captured scenes, edit the digital twin to generate diverse virtual scenarios, and conduct novel view synthesis through differentiable rendering to simulate image data. The present systems are fully automatic.

Modern autonomous driving systems, or more generally, intelligent mobility services such as advanced driving assistance system (ADAS), rely heavily on data. Deep learning, or artificial intelligence, has been a core technique to enable some of these systems. Deep learning techniques train on a large amount of data and neural networks automatically learn value knowledge for specific tasks. Mobility is a safety-critical area, which means that extensive verification under different scenarios is needed before real deployment. However, collecting real data to cover all possible scenarios with complex traffic scenes is difficult, if not impossible, and costly. Simulation provides an alternative for data source without extensive human effort to create three-dimensional (3D) assets, which is much more cost-effective.

In accordance with embodiments of the present invention, automatic asset creation and editing is provided to generate new traffic scenarios without manually creating 3D assets. In particular, traffic agents are simulated, as traffic agents are an important element on the road, e.g., most accidents are caused by moving agents instead of static scene elements. A traffic agent may refer to any entity or object that interacts with or influences the flow of traffic. This can include vehicles, pedestrians, cyclists, traffic signals, road signs, and other elements that affect the driving environment. Some examples of traffic agents that may be present in a driving scene image can include cars, trucks, buses, and other motor vehicles, pedestrians crossing streets or walking on sidewalks, cyclists and motorcyclists, traffic lights and signals, animals on or near the roadway, etc.

Due to the high resolution and semantic richness of images, the present embodiments automatically simulate photorealistic camera data corresponding to diverse traffic scenarios defined by the occurrence as well as the appearance of traffic agents. This is achieved by editing existing real sequences that have already been collected. New simulated data can be supplied to the training and verification of the autonomous driving system or ADAS.

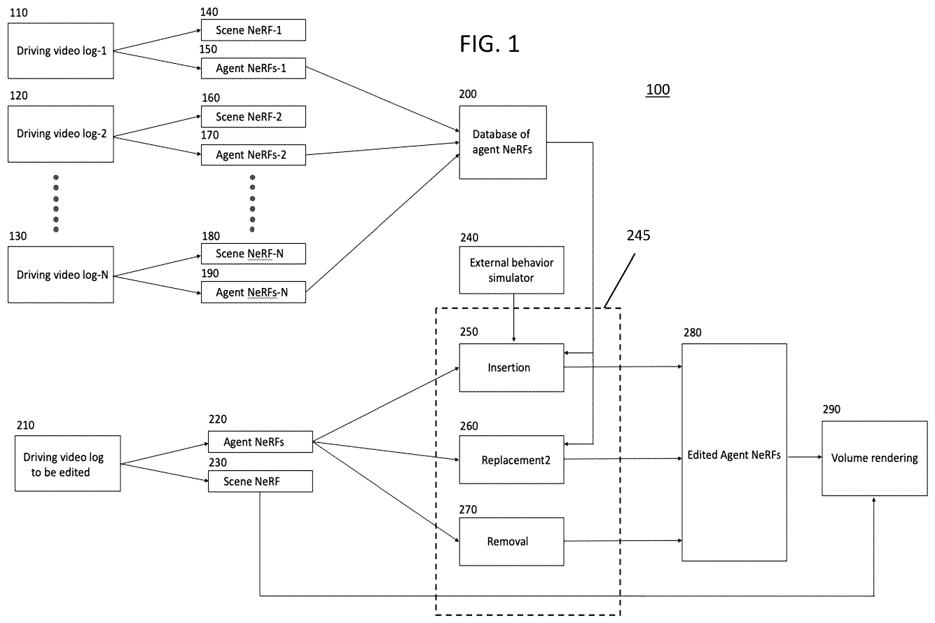

Referring now in detail to the figures in which like-numerals represent the same or similar elements and initially to FIG. 1, a system/method 100 for view synthesis using a traffic agent database is described and shown in accordance with embodiments of the present invention.

Blocks 110, 120, 130 include driving video logs. Driving video logs include real driving video sequences and can be employed to build a database 200 of agent NeRFs as 3D object assets. In accordance with embodiments of the present invention, 3D object assets are automatically created from real driving data without manual effort, leading to a low-cost and scalable system for wide deployment. This is in contrast with a traditional asset creation pipeline in an existing autonomy system or game industry, where a large number of artists are hired to manually create computer aided design (CAD) models as 3D assets.

In blocks 140, 150, 160, 170, 180 and 190, each driving video log has a scene NeRF and an agent NeRF trained. For each driving sequence, the scene NeRF and the separate agent NeRF are trained for each agent in the scene. The agent NeRFs are collected and stored in a database 200 of agent NeRFs from all the driving sequences.

A driving video log 210 to be edited is provided that includes a driving sequence that will be used to build a digital twin and edit the driving video log 210 with simulated agents. An agent NeRF and a scene NeRF are extracted from the driving video log 210 to be edited in blocks 220 and 230. The agent NeRF and the scene NeRF from blocks 220 and 230 are employed to build a digital twin 245 of the driving log 210 to be edited.

An external behavior simulator 240 is employed to generate insertion locations and orientation of agents, as well as driving trajectories of the agents, change can change with time. In block 250, based on outputs of the external behavior simulator, agent NeRFs are selected from the pre-built database 200 of agent NeRFs to insert into a traffic scene in accordance with the following criteria to generate new traffic scenarios.

The criteria are provided to ensure photorealism and can include camera viewpoints for an inserted agent that need to be similar to the camara viewpoints where that agent was captured to build its NeRF. For example, if an agent was only observed from its rear view in the driving log previously used to establish its agent NeRF, and yet it is inserted into the traffic where it is observed mainly from its front view, significant rendering artifacts would arise since NeRF lacks generative capability to hallucinate the front view from only the rear view of an agent. Hence, view consistency is needed to ensure photorealism. Further, the illumination of the inserted agent needs to be consistent with the environment in the real log to be edited to avoid different lighting conditions across environments. Similarly, shadows of the inserted agent need to be consistent with the environment in the real log to be edited. Based on this criteria, an agent can be selected from the database 200 of agent NeRFs (assets) that were created from all real driving logs. The database 200 of agent NeRFs is composed of all real driving logs that have been collected. The agent NeRFs are curated to form a database. The agent NeRFs can be classified based on object type, positions, lighting effects and direction, shadow effects and direction, speed effects, etc.

The digital twin 245 is created as 3D assets for a real log of a driving scene. Taking input from the external behavior simulator 240, the occurrence of traffic agents is edited to create diversity in traffic patterns. An appearance of traffic agents is also edited to create diversity in sensor data. More specifically, NeRF is employed as a scene representation of 3D assets, where the surrounding environment is decomposed as background scene and traffic agents. A scene NeRF is learned for the background of the scene, and the agent NeRF for each traffic agent in the scene, assuming a 3D bounding box is provided for each object to understand its spatial location, orientation, and size.

For both the background (scene NeRF) and agent NeRF, instant-Neural Graphics Primitives (NGP) can be followed to represent the scene as a feature grid with hash encoding for efficient training. Instant-NGP is a technique for representing and rendering 3D scenes using neural networks. Instant-NGP allows for fast training and real-time rendering of complex 3D environments from a set of 2D images. Instant-NGP permits the use of multi-resolution hash encodings to efficiently represent 3D scenes. This allows the neural network to focus on important details at different scales. The ability to represent various types of 3D content, including NeRF-like radiance fields, signed distance functions, and volumetric density fields makes Instant-NGP applicable to tasks like novel view synthesis, 3D reconstruction, and volumetric rendering.

Having the digital twin 245 of the environment, editing of traffic agents can be performed. The external behavior simulator 240 takes as input the traffic scenario from the real logs, and outputs an edited traffic scenario, where the possible editing includes removal in block 270 of one or multiple agents from the traffic scene, or insertion in block 250 of extra agents into the traffic together with its driving trajectories. Agents can be randomly identified for removal from the traffic to add diversity to the layer synthesized images/scene.

In block 260, agent NeRFs can be selected from the database 200 of agent NeRFs to replace existing agents in the driving log in accordance with the criteria for photorealism. Agents can be replaced by other agents from the database 200.

Then, the agent NeRF can be edited according to the output of the external behavior simulator 240. This can include lighting changes, speed changes, or other behavior changes.

To remove an agent, a corresponding 3D bounding box and the agent NeRF therein are removed. When a ray to be rendered passes through this 3D bounding box, the corresponding space is treated as empty. It is more complicated to insert an additional agent into the traffic. The goal here is to seamlessly insert a 3D bounding box along with its agent NeRF into the traffic. Similarly, for the editing of object appearance, any agents (one or multiple) can be replaced in the scene with other agents from the database 200 of agent assets (and maintain their driving trajectories), following the photorealism criteria described above. In this way, photorealistic editing of both occurrence and appearance of traffic agents is provided to increase the diversity of the data.

In block 280, edited agent NeRFs are provided from the activities of blocks 250, 260 and 270. To leverage the categorical prior of traffic agents, each agent can be represented as a learnable latent code and a hyper-network can be applied to map the latent code to parameters of a feature grid. The feature grids are then decoded into density and color given a point in the 3D space, using a multilayered perceptron (MLP).

The learnable latent code may represent a compact encoding of information about the agent. Latent code can be generated by machine learning models, such as autoencoders or generative models, to encode high-dimensional input data into a lower-dimensional latent space. In some cases, latent code may enable more efficient processing or analysis of complex data by working with the condensed representation rather than a full input.

The hyper-network may be configured to take this latent code as input and generate parameters for a feature grid that captures relevant characteristics of the agent. The hyper-network may include a neural network architecture that generates the weights for another neural network. The hyper-network takes some input and produces parameters of a main network as its output.

The feature grid parameters generated by the hyper-network may correspond to properties such as, object type, lighting conditions shadowing, etc. By learning to map the latent code to these grid parameters, the system may be able to capture and represent intricate patterns and relationships within the data. The feature grid produced through this mapping process may serve as input to subsequent analysis modules, such as anomaly detection algorithms or visualization tools. By leveraging the learned mapping from latent codes to grid parameters, the system may be able to efficiently process and analyze large-scale data while capturing relevant patterns and characteristics.

In block 290, volume rendering is performed. The edited agent NeRFs are composed with the scene NeRF, and passed into a volume rendering pipeline for new image generation. The volume rendering, in block 290, simulate images, in NeRF. Since the agent 3D bounding boxes often encapsulate the ground underneath and its shadow on the ground moves together with the agent, the compositional NeRF is able to associate the shadow with the agent and include it as a part of the agent NeRF.

A hash map is used to efficiently generate feature vectors as encoding for each 3D point, following the highly optimized implementation in Instant-NGP. It is computationally infeasible to represent each object with a separable hash grid. Instead, each object is represented as a learnable latent code, and a shared hypernetwork is used to map the latent code to the parameters of the hash grid. MLPs are employed for density and color regressing, followed by standard volume rendering to obtain synthesized images of the objects. The NeRF obtained can be used as 3D assets and applied in simulation systems to generate diverse and photo-realistic object image data.

Neural Radiance Field (NeRF) represents a radiance field with a continuous neural network f: (x,d)→(c,σ), mapping spatial location x=(x,y,z) and viewing direction d=(θ,ϕ) to the RGB color c and volumetric density σ at that point. To render an image, NeRF casts rays through each pixel of the image and samples points along each ray. The network is queried at each point to estimate color and density, which are then composed into the final pixel color using a volume rendering equation. This equation accounts for both the accumulated color along the ray and the probability that the ray travels through the scene without hitting any surfaces. The loss function L_{rgb} is the mean squared error between the predicted and true colors of the training images.

In accordance with the present embodiments, features center around the capability for photorealistic editing of occurrence and appearance of agents in traffic scenes without manually creating 3D assets. This is different from a traditional simulation pipeline which requires graphic experts to manually create and edit 3D assets. The present invention includes the removal and the insertion of agents to create new traffic scenarios, as well as the editing of agent appearance to create diversity in sensor data. The database 200 of agent NeRFs is created from real logs. The agents in the database 200 are selected to insert agents for traffic editing, replace existing agents for appearance editing or simply remove agents from the scene. The present invention employs photo-realism criteria for agent selection that account for viewpoint consistency, illumination and lighting conditions, shadow consistency, etc. to ensure photorealism.

A 3D hash feature grid, which is an original scene representation as a hash feature grid, following Instant-NPG is provided. A rendering ray is generated. View rays are sampled to render the corresponding pixels. Further, points are sampled along the ray to retrieve the corresponding features from the hash feature grid. An MLP takes the features at a sampled point as input and returns a density at that point as well as a corresponding geometric feature vector. The MLP takes the geometric feature vector and a viewing direction as input, and returns the color. With the density and color, the volume rendering can be provided. The volume rendering in block 290 can include a standard volume rendering to render pixels for each ray. An image is obtained that includes an entire synthesized image from the rendering, which is supervised by ground truth during training.

In accordance with embodiments of the present invention, systems and methods employ NeRF to develop a fully automatic pipeline for image simulation. The present systems take as input real driving logs, build a 3D digital twin (e.g., 3D reconstruction with NeRF) for captured scenes, edit the digital twin to generate diverse virtual scenarios, and conduct novel view synthesis through differentiable rendering to simulate image data.

A NeRF representation in accordance with embodiments of the present invention is employed as a component which receives geometric feature vectors and the viewing ray directions. The geometric feature vectors are input to hash and viewing ray direction encoding. NeRF representation lies in a hash grid that efficiently maps each 3D point into a feature vector, which are then passed to MLPs for decoding density and color, and then volume rendering in block 290 follows to synthesize images from novel views. In this way, NeRF training is supplied with rich geometry and semantic prior of the scene, leading to improved view performance.

The hash grid or map is used to efficiently generate feature vectors as encoding for each 3D point, following the highly optimized implementation in Instant-NGP. Each object can be represented as a learnable latent code, and a shared hypernetwork is used to map the latent code to the parameters of the hash grid.

As employed herein, MLPs have been described to provide a feedforward artificial neural network, consisting of fully connected neurons to distinguish data. While MLPs are described, other artificial machine learning systems can also be employed in accordance with embodiments of the present invention to predict outputs or outcomes based on input data, e.g., image data. For example, the external behavior simulator 240 can be implemented as a deep neural network training on objects from thousands, millions or more scenes. The external behavior simulator 240 learns agents and scenes and can employ artificial intelligence to select objects that can be inserted, replaced or removed from a scene to be edited in accordance with the photorealism criteria.

Given a set of input data, a machine learning system can predict an outcome, e.g., a best agent that meets photorealism criteria and its placement position within a scene. The machine learning system will likely have been trained on much training data in order to generate its model. It will then predict the best outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, which is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

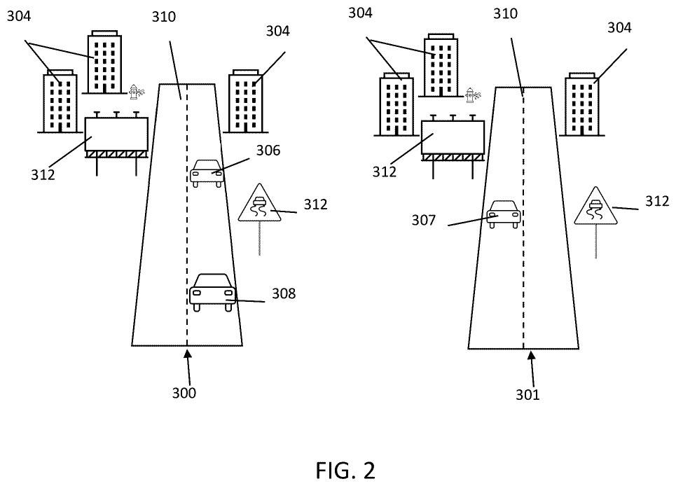

Referring to FIG. 2, an example of a synthesized image generated in accordance with systems described herein is shown. A scene of a reference image 300 or prior includes buildings 304 or other structures and a number of vehicles 306 and 308 (agents to be removed), which can be in motion. A synthesized image 301 generated in accordance with the present embodiments includes images of a vehicle 307 (added agent) that accounts for photorealism criteria to accurately portray a realistic image with static objects 312, buildings 304, dynamic objects that accurately account for the background. Here, the vehicle 307 is generated on the left side of a road 310 at a different depth when compared to the vehicles 306, 308 of the reference image 300. By being able to generate synthetic images with accurate depth, model training data can more easily be generated with labels without human interaction.

Synthetic images can be employed for training systems with little human intervention. Synthetic images can enable self-training and help to account for novel occurrences and objects in a scene.

After collecting the data, model training occurs using the data collected. The model training includes training an initial perception model. The perception model can include sensor fusion data, which merges data from at least two sensors. Perception refers to the processing and interpretation of sensor data to detect, identify, track and classify objects. Sensor fusion and perception enable, e.g., an automated driver assistance system (ADAS) to develop a 2D or 3D model of the surrounding environment that feeds into a control unit for a vehicle. Other applications can include inspection machines in a manufacturing environment, computer visions, cyber security applications, etc. The perception model can also include bird's eye view (BEV) perspectives as trajectory predictions. Trajectory prediction includes information for predicting short-term (1-3 seconds) and long-term (3-5 seconds) spatial coordinates of various vehicles or objects, e.g., cars, pedestrians, etc.

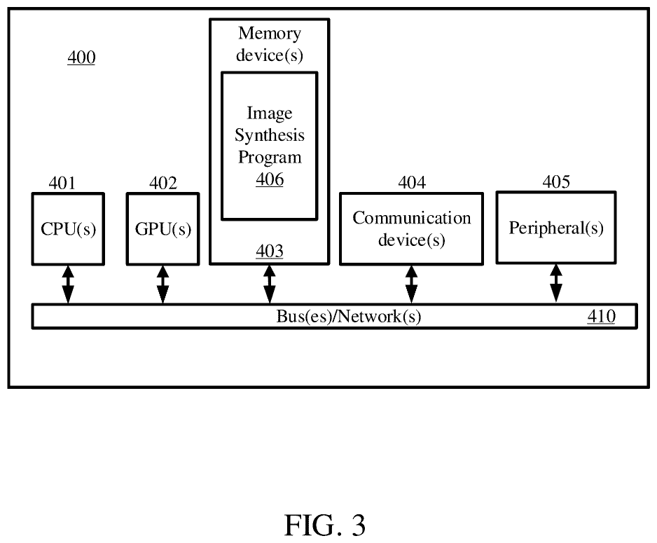

Referring to FIG. 3, a block diagram is shown for an exemplary processing system 400, in accordance with an embodiment of the present invention. The processing system 400 includes a set of processing units (e.g., CPUs) 401, a set of GPUs 402, a set of memory devices 403, a set of communication devices 404, and a set of peripherals 405. The CPUs 401 can be single or multi-core CPUs. The GPUs 402 can be single or multi-core GPUs. The one or more memory devices 403 can include caches, RAMs, ROMs, and other memories (flash, optical, magnetic, etc.). The communication devices 404 can include wireless and/or wired communication devices (e.g., network (e.g., WIFI, etc.) adapters, etc.). The peripherals 405 can include a display device, a user input device, a printer, an imaging device, and so forth. Elements of processing system 400 are connected by one or more buses or networks (collectively denoted by the figure reference numeral 410).

In an embodiment, memory devices 403 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 403 store program code or software 406 for implementing one or more functions of the systems and methods described herein for synthesizing images including storing and employing artificial intelligence models. The memory devices 403 can store program code for implementing one or more functions of the systems and methods described herein.

Of course, the processing system 400 may also include other elements (not shown), as readily contemplated by one of skill in the art, as well as omitting certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 400.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

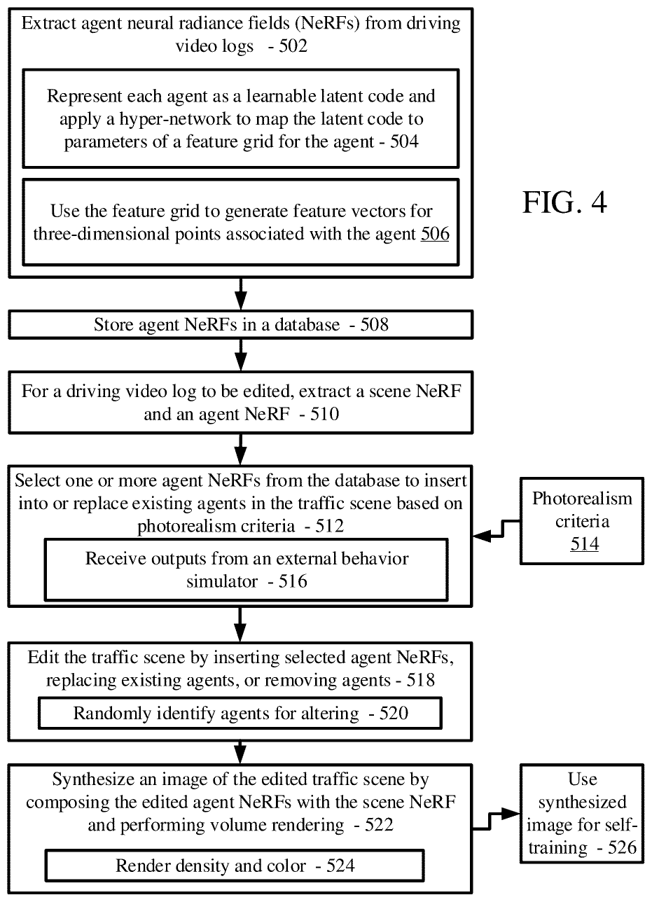

Referring to FIG. 4, a computer-implemented method for synthesizing an image is described in accordance with embodiments of the present invention. In block 502, agent neural radiance fields (NeRFs) are extracted from driving video logs. In block 504, each agent can be represented as a learnable latent code; and a hyper-network can be applied to map the latent code to parameters of a feature grid for the agent. In block 506, the feature grid can be used to generate feature vectors for three-dimensional points associated with the agent.

In block 508, agent NeRFs are stored in a database. In block 510, for a driving video log to be edited, a scene NeRF and an agent NeRF are extracted from the driving video log to be edited. In block 512, one or more agent NeRFs are selected from the database to insert into or replace existing agents in a traffic scene of the driving video log based on photorealism criteria. In block 514, the photorealism criteria can include at least one of view consistency between inserted agents and the traffic scene, illumination consistency between inserted agents and the traffic scene, or shadow consistency between inserted agents and the traffic scene. Other criteria can also be employed.

In block 516, outputs can be received from an external behavior simulator indicating insertion locations, orientations, and driving trajectories for agents to be inserted into the traffic scene. A digital twin can be employed to enable the editing and receive the outputs of the external behavior simulator.

In block 518, the traffic scene is edited by at least one of inserting the selected agent NeRFs into the traffic scene, replacing existing agents in the traffic scene with a selected agent NeRFs, or removing one or more existing agents from the traffic scene. In block 520, the editing the traffic scene can be done randomly to identify one or more existing agents for altering (e.g., removal, insertion, substitution, varying color, lighting shadow, etc.) from the traffic scene. In block 522, an image of the edited traffic scene is synthesized by composing the edited agent NeRFs with the scene NeRF and performing volume rendering. In block 524, the feature vectors associated with the agents can use multilayer perceptrons to determine density and color for points along rendering rays. The volume rendering can be performed using the determined density and color.

In block 526, an autonomous driving system can employ the synthesized images for self-training. For example, while avoiding objects a self-training method learns local map regions, local hazards, signs, etc. while driving to improve performance with synthesized images for training.

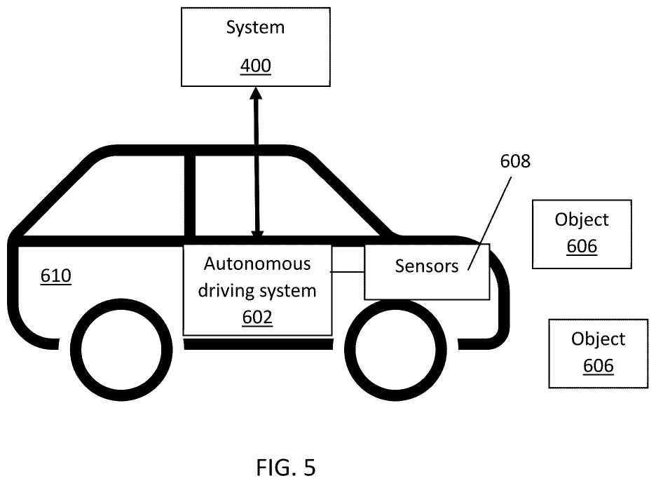

Referring to FIG. 5 with reference to FIG. 3, embodiments of the present invention can be employed in any number of practical applications. A self-training system that discovers and identifies novel objects and generates synthesized images in a perception model can be employed in any computer vision scenario. These systems can be employed in autonomous driving applications. In an embodiment, a vehicle 610 can include an autonomous driving system 602 (e.g., Advanced Driving Assistance System (ADAS)). The autonomous driving system 602 includes one or more sensors 608 that are configured to perceive objects 606 with which the vehicle 610 will encounter. The autonomous driving system 602 can employ computer vision to detect the objects and respond by avoiding them.

The autonomous driving system 602 can interact with or be a part of system 400, which includes software 406 (FIG. 3). Software 406 can generate novel scenes and can update a perception model by providing additional training data. Software 406 can be distributed or can exist on the vehicle 610 or remotely from the vehicle 610 and be accessible over a network, such as, e.g., the Cloud/internet, etc.

Since the system 400 is self-training, the system 400 can be employed concurrently with other functions of the autonomous driving system 602. For example, while avoiding objects 606, the system 400 can be learning at the same time to improve performance by synthesizing images for training. In addition, perception models can be improved by using the data to determine any deficiencies in the models' ability to correctly predict objects.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for synthesizing an image, comprising:
extracting agent neural radiance fields (NeRFs) from driving video logs;
storing agent NeRFs in a database;
for a driving video log to be edited, extracting a scene NeRF and agent NeRFs from the driving video log to be edited;
selecting one or more agent NeRFs from the database to insert into or replace existing agents in a traffic scene of the driving video log based on photorealism criteria;
editing the traffic scene by at least one of inserting a selected agent NeRF into the traffic scene, replacing existing agents in the traffic scene with a selected agent NeRF, or removing one or more existing agents from the traffic scene; and
synthesizing an image of an edited traffic scene by composing edited agent NeRFs with the scene NeRF and performing volume rendering.

2. The method of claim 1, wherein the photorealism criteria include at least one of:
view consistency between inserted agents and the traffic scene, illumination consistency between inserted agents and the traffic scene, or shadow consistency between inserted agents and the traffic scene.

3. The method of claim 1, further comprising:
receiving outputs from an external behavior simulator indicating insertion locations, orientations, and driving trajectories for agents to be inserted into the traffic scene.

4. The method of claim 1, wherein editing the traffic scene comprises:
randomly identifying one or more existing agents for removal from the traffic scene.

5. The method of claim 1, further comprising:
representing each agent as a learnable latent code; and
applying a hyper-network to map the latent code to parameters of a feature grid for each agent.

6. The method of claim 5, further comprising: using the feature grid to generate feature vectors for three-dimensional points associated with an agent.

7. The method of claim 6, wherein synthesizing the image comprises:
decoding the feature vectors using multilayer perceptrons to determine density and color for points along rendering rays; and
performing volume rendering using the density and color.

8. A system for synthesizing an image, comprising:
a hardware processor; and
a memory storing a computer program which, when executed by the hardware processor, causes the hardware processor to:
extract agent neural radiance fields (NeRFs) from driving video logs;
store agent NeRFs in a database;
for a driving video log to be edited, extract a scene NeRF and agent NeRFs from the driving video log to be edited;
select one or more agent NeRFs from the database to insert into or replace existing agents in a traffic scene of the driving video log based on photorealism criteria;
edit the traffic scene by at least one of inserting a selected agent NeRF into the traffic scene, replacing existing agents in the traffic scene with the selected agent NeRF, or removing one or more existing agents from the traffic scene; and
synthesize an image of the traffic scene by composing edited agent NeRFs with the scene NeRF and performing volume rendering.

9. The system of claim 8, wherein the photorealism criteria include at least one of:
view consistency between inserted agents and the traffic scene, illumination consistency between inserted agents and the traffic scene, or shadow consistency between inserted agents and the traffic scene.

10. The system of claim 8, wherein the computer program further causes the hardware processor to:
receive outputs from an external behavior simulator indicating insertion locations, orientations, and driving trajectories for agents to be inserted into the traffic scene.

11. The system of claim 8, wherein editing the traffic scene comprises:
randomly identifying one or more existing agents for removal from the traffic scene.

12. The system of claim 8, wherein the computer program further causes the hardware processor to:
represent each agent as a learnable latent code; and
apply a hyper-network to map the latent code to parameters of a feature grid for each agent.

13. The system of claim 12, wherein the computer program further causes the hardware processor to:
use the feature grid to generate feature vectors for three-dimensional points associated with an agent.

14. The system of claim 13, wherein synthesizing the image comprises:
decoding the feature vectors using multilayer perceptrons to determine density and color for points along rendering rays; and
performing volume rendering using the density and color.

15. A non-transitory computer-readable storage medium storing instructions that, when executed by a processor, cause the processor to perform a method for synthesizing an image, the method comprising:
extract agent neural radiance fields (NeRFs) from driving video logs;
store agent NeRFs in a database;
for a driving video log to be edited, extract a scene NeRF and agent NeRFs from the driving video log to be edited;
select one or more agent NeRFs from the database to insert into or replace existing agents in a traffic scene of the driving video log based on photorealism criteria;
edit the traffic scene by at least one of inserting a selected agent NeRF into the traffic scene, replacing existing agents in the traffic scene with the selected agent NeRF, or removing one or more existing agents from the traffic scene; and
synthesize an image of the traffic scene by composing edited agent NeRFs with the scene NeRF and performing volume rendering.

16. The non-transitory computer-readable storage medium of claim 15, wherein the photorealism criteria include at least one of:
view consistency between inserted agents and the traffic scene, illumination consistency between inserted agents and the traffic scene, or shadow consistency between inserted agents and the traffic scene.

17. The non-transitory computer-readable storage medium of claim 15, wherein the method further comprises:
receiving outputs from an external behavior simulator indicating insertion locations, orientations, and driving trajectories for agents to be inserted into the traffic scene.

18. The non-transitory computer-readable storage medium of claim 15, wherein editing the traffic scene comprises:
randomly identifying one or more existing agents for removal from the traffic scene.

19. The non-transitory computer-readable storage medium of claim 15, wherein the method further comprises:
representing each agent as a learnable latent code; and
applying a hyper-network to map the latent code to parameters of a feature grid for each agent.

20. The non-transitory computer-readable storage medium of claim 19, wherein synthesizing the image comprises:
using the feature grid to generate feature vectors for three-dimensional points associated with each agent;
decoding the feature vectors using multilayer perceptrons to determine density and color for points along rendering rays; and
performing volume rendering using the density and color.
